(19) United States
(12) Patent Application Publication
(10) Pub. No.: US 2026/0244385 A1
(43) Pub. Date: Aug. 20, 2026

(54) METHOD FOR OPERATING AN ASSEMBLY FORMED OF A DIGITAL PRINTING MACHINE AND A FOLDING MACHINE, ASSEMBLY OF SUCH MACHINES, AND PRODUCTION METHOD FOR CHANGING JOBS

(71) Applicant: Heidelberger Druckmaschinen AG, Heidelberg (DE)

(72) Inventors: Rainer Wolf, Stuttgart (DE); Axel Diehl, Wiesbaden (DE); Harald Wörner, Wiesloch (DE); Ulrike Seethaler, Mauer (DE); Wladislaw Schewtschenko, Ludwigsburg (DE); Gerhard Lubberger, Steinheim (DE); Jürgen Knaupp, Mundeslheim (DE); Andreas Baier, Burgstetten (DE)

(21) Appl. No.: 19/544,128

(22) Filed: Feb. 19, 2026

(30) Foreign Application Priority Data
Feb. 19, 2025 (DE) 10 2025 106 181.5

(51) Int. Cl. G06F 3/12; B41J 3/44; B65H 45/14; B65H 45/28; G06K 15/00

(52) U.S. Cl. CPC G06F 3/1264; B41J 3/44; B65H 45/14; B65H 45/28; G06F 3/1204; G06F 3/1254; G06K 15/404; B65H 2301/5121; B65H 2301/515; B65H 2553/42; B65H 2557/64; B65H 2801/31; G06K 2215/101

(57) ABSTRACT

A method for operating an assembly of a digital printing machine and a folding machine, wherein the digital printing machine creates changing jobs of printed products based on respective job data, and the folding machine finishes the printed products by folding, cutting, and/or grooving printed sheets. Multiple jobs to be finished with like or similar settings are grouped to form respective series of consecutive jobs. A series-specific set of settings is specified for each series and digitally saved for the folding machine. The series are sequentially printed in the digital printing machine and finished at the folding machine and the series-specific settings are automatically provided. The process enables enhanced productivity of machines for manufacturing and finishing printed products in an assembly, especially in print shops with machinery for the press and post-press areas.

### CROSS-REFERENCE TO RELATED APPLICATION

This application claims the priority, under 35 U.S.C. § 119, of German Patent Application DE 10 2025 106 181.5, filed February 19, 2025; the prior application is herewith incorporated by reference in its entirety.

### FIELD AND BACKGROUND OF THE INVENTION

The invention lies in the technical field of the graphics industry and particularly in the field of folding flexible sheet-shaped printing substrates and in the field of industrial, i.e., high-quality and high-productivity, manufacture of folded products such as, e.g., brochures, preferably from paper, cardboard, paperboard, plastic, or composite material, particularly from printed paper.

More particularly, the invention relates to a method for operating an assembly of at least one digital printing machine and at least one folding machine, wherein the digital printing machine creates changing jobs of printed products based on respective job data and the folding machine finishes the printed products delivered thereto by folding, cutting, and/or grooving sheets, and wherein the folding machine is set for each job. The invention further relates to a machine assembly and a production method for the automatic production of changing jobs of printed products printed and encoded in a digital printing machine as well as finished in a finishing machine.

In the prior art, industrial folding machines are known with preferably multiple units, e.g., cutting stations and/or folding stations, for manufacturing folded products from a sheet-shaped printing substrate from paper, for example, and conveyor units for moving the folded products. The cutting stations may comprise, e.g., slitter shafts. The folding stations may be, e.g., buckle folding units and/or knife folding units for creating preferably multiple folding lines. The conveyor stations may be, e.g., roller tables with inclined conveyor rollers. Such folding machines typically also comprise a feeder, e.g., stack feeder, for the sheets to be folded, and an output tray for the folded products. The sheets to be folded may preferably be conveyed as a stream and more preferably as a shingle stream to the first folding unit. In high-end machines, conveying as what is known as a shingle is also possible between the folding units. Such folding machines further comprise a machine control in the form of a digital computer with control software.

In the prior art, digital printing machines are also known. They may be designed as ink-jet printing machines and may comprise, e.g., a feeder, multiple printing units for multicolor printing, in particular CMYK printing, and an output for printed sheets.

The printed sheets may be transitioned from the digital printing machine to the folding machine and be finished there. The sheets may also undergo edge trimming, and the edge strips cut off may be removed. United States Patent No. 3,252,366 and its counterpart German Patent No. DE 1253033 B shows blow air being employed when removing edge trimmings, wherein mechanical guide elements are provided and the blow air only supports removal, in particular with an air cushion. The document does not describe that the blow air may be set or switched off in a format-dependent manner.

It is also already known in the prior art to provide the sheets with a barcode in the digital printing machine and to automatically sense this barcode in the feeder of the folding machine and to detect based thereon when a production job changes, and therefore to stop the folding machine to manually make alterations to settings.

On the part of the manufacturers of graphics articles—that is, e.g., printing shops with prepress, printing itself, and postpress—there is a constant desire for an improvement, that is, preferably a marked increase, in production speed while maintaining or, if possible, enhancing product quality. Also, there is a desire to automate production further, pare down operating personnel, and thereby lower costs and stay competitively viable.

### SUMMARY OF THE INVENTION

Therefore, it is an object of the present invention to provide an improvement compared to the prior art which in particular enables enhancing productivity of machines for manufacturing and finishing printed products in an assembly.

With the above and other objects in view there is provided, in accordance with the invention, a method for operating an assembly formed of at least one digital printing machine and at least one folding machine, wherein the digital printing machine is configured to create changing jobs of printed products based on respective job data, and the folding machine is configured to finish the printed products by at least one of folding, cutting, or grooving sheets, and wherein the folding machine is set for each of the jobs. The novel method comprises:

grouping, in an automated manner, multiple jobs to be finished with like or similar settings in terms of finishing, to form respective series of consecutive jobs;

for each series of consecutive jobs, specifying a set of series-specific settings and digitally saving the series-specific settings for the folding machine; and

sequentially creating the series with the digital printing machine and finishing at the folding machine with the series-specific settings each provided in an automated manner.

In other words, the method according to the invention for operating an assembly of at least one digital printing machine and at least one folding machine, wherein the digital printing machine creates changing jobs of printed products based on respective job data, and the folding machine finishes the printed products delivered thereto by means of folding, cutting, and/or grooving of sheets, and wherein the folding machine is set for each job, is characterized in that multiple jobs, which are each finished with like or similar settings in terms of finishing, are grouped in an automated manner to form respective series of consecutive jobs, that for each series, a series-specific set of settings is specified and digitally saved for the folding machine, and that the series are created sequentially with the digital printing machine and finished at the folding machine with the set of series-specific settings each provided in an automated manner.

With the above and other objects in view there is also provided, in accordance with the invention, an assembly of at least one digital printing machine and at least one folding machine, wherein the assembly further comprises at least one digital computer. The assembly is characterized in that it is operable for performing the method as summarized above and described below in detail, wherein the computer transmits the job data to the digital printing machine and the series-specific settings to the folding machine.

With the above and other objects in view there is also provided, in accordance with the invention, a production method for the automatic production of changing jobs of printed products printed and encoded in a digital printing machine as well as finished in a finishing machine. The method is characterized in that both the digital printing machine and the folding machine are operated in a push-to-stop mode in a computer-controlled manner, wherein job series of like or similar jobs are created in a computer-controlled manner and provided with changing encoding and are finished sequentially upon changing encoding with changing series-specific settings.

The invention advantageously enables enhancing productivity of machines for manufacturing and finishing printed products in an assembly. The invention is advantageously employed in printing shops with machinery for the press and postpress areas.

A further advantage of the invention is that standardized production jobs for a combination of printing and postpress may be defined and digitally stored. Such jobs may then be assigned to the appropriate machines by a centralized (workflow) computer and launched on them. The relevant machines may then preferably be operated in what is known as a push-to-stop mode. Also, each machine preferably exhibits its own machine computer.

In this specification, the term “push-to-stop mode” should be understood as follows: if a machine, e.g., the digital printing machine or the finishing machine, in particular the folding machine, is operated in this mode, many or all of the settings are preferably carried out in a computer-controlled manner, and operating personnel only need to intervene if they detect, say, a production error or a quality error. Such an intervention may be pausing the machine, manually making alterations to settings, and restarting the machine. As such errors are very rare in the highly automated production process, in the push-to-stop mode, uninterruptible production is usually possible across many jobs. Ideally, the machine is not stopped at all and produces automatically and without any interruptions. It may also be provided that the machine itself detects that alterations to settings need to be made which can only be made by hand. In this case, the machine may autonomously pause production and make the operator aware of the alterations to settings to be made. The operator may also be instructed as to which alterations are to be made where and how. Thereafter, the machine may resume production.

In this specification, the term “assembly” should be understood as follows: two or more machines form a (machine) assembly if they are operated together for the production of printed products, that is, if a first machine implements at least a first production step (e.g., printing) and a second machine implements at least a second production step (e.g., finishing, such as cutting and/or folding). Preferably, a common computer supplies both machines with the data necessary to do this. This computer may be a workflow computer for a print shop workflow.

In this specification, the term “like or similar settings [in terms of finishing]” should be understood as follows: like settings are identical and thus unaltered settings when finishing two or more jobs; similar settings are settings which would only require slight alterations to settings when finishing two or more jobs and can therefore also be processed with like settings without any loss in quality.

For standard jobs, operating personnel advantageously does not or barely has to intervene. Manual alterations to settings may still be needed, as appropriate, only for rare special jobs.

Further general advantages:
processing a stack with different folding and cutting products without any intervention by the operator.
no incorrect input of parameters by the operator;
operation by unskilled personnel is possible;
quick changes between different jobs; and

Further advantages specifically of the blow air for edge trimmings:
solution fits below the existing protective cover.
Preferred further developments of the invention as an operating method are described in the following. These further developments and features may, unless they are technically exclusive of each other, also be combined.
more flexible positioning than mechanical scrapers as less installation space is needed; and
automatic switching on and off without any operator intervention;

One further development may be characterized in that the sheets are transitioned from an output of the digital printing machine to a feeder of the folding machine. This may be carried out by the operating personnel or preferably in an automated manner, e.g., employing conveyor means or robot arms. It may be provided that the sheets are each provided with printed encoding which is created in the digital printing machine using printing technology, that is, e.g., printed on with ink. The encoding has previously been created digitally in prepress and preferably integrated with the image to be printed, e.g., in its marginal region. It may be provided that the encoding is designed as a barcode or as a QR code or as a sequence of characters and/or numbers. It may be provided that the encoding is present in the marginal region of a trailing edge of the sheet to be processed. It may be provided that the encoding is sensed in the feeder of the folding machine, preferably automatically. It may be provided that a camera or a sensor is used for sensing. The camera or the sensor may be arranged at a suction head of the feeder. The camera or the sensor may be arranged above the sheet transport plane and oriented downward. It may be provided that the encoding is used to provide the series-specific set of settings respectively needed for finishing. It may be provided that, upon changing encoding, the series-specific set of settings is changed automatically. The encoding may comprise, e.g., an ID which labels the print job or even the individual printed sheet in the print job. It may be provided that the folding machine is operated in a push-to-stop mode, i.e., that the folding machine processes changing jobs automatically and sequentially without any controlling intervention by an operator. It may be provided that the operator pauses automatic processing of the folding machine in the push-to-stop mode in case an error is detected.

One further development may be characterized in that the sheets undergo edge trimming in the folding machine. This edge trimming is preferably carried out in a longitudinal direction, i.e., in a transport direction of the sheets. The edge trimming is preferably carried out on both sides, e.g., with circular slitters. It may be provided that the sheets initially undergo edge trimming and are then folded. It may be provided that any edge strips arising during edge trimming are carried off. It may be provided that blow air is used for carrying off the edge strips. It may be provided that, to expel the blow air in a directed manner, at least one blow-air pipe is used, preferably one pipe each at each longitudinal edge of the transported sheets. It may be provided that the blow-air delivery is automatically activated or deactivated or maintained upon changing encoding. It may be provided that the blow-air pipe is set depending on the format of the sheets to be processed, preferably automatically and alternatively by hand. It may be provided that the format setting is automatically altered or maintained upon changing encoding.

Preferred further developments of the invention as a machine assembly are described in the following. These further developments and features may, unless they are technically exclusive of each other, also be combined.

One further development may be characterized in that the folding machine has at least one station which is designed as a slitter shaft station and/or a buckle folding station. It may be provided that the station comprises at least one automatically activatable and deactivatable slitter shaft. The slitter shaft may be equipped with one circular slitter or with two or more circular slitters; alternatively or additionally, tools for perforating or grooving may also be present on the respective shaft. The shaft be positioned and fixed in a job-specific manner, preferably automatically and alternatively by hand. It may be provided that the station comprises multiple slitter shafts which are variously equipped with slitters, e.g., for various standard jobs. It may be provided that the station comprises multiple slitter shafts which are configured for various format widths of the sheets. It may be provided that automatic activating and deactivating of the slitter shaft is carried out via at least one setting which is part of the series-specific set of settings. At least one adjuster may be employed for this. It may be provided that the buckle folding station is downstream of the slitter shaft station.

One further development may be characterized in that the folding machine has a feeder for sheets to be processed. It may be provided that the feeder is designed as a flat stack feeder. It may be provided that the feeder comprises a camera or a sensor which senses printed encoding on the sheets.

One further development may be characterized in that the folding machine has an output. It may be provided that the output comprises a separating device which handles changing jobs such that they are separable from one another for further handling. Separating may be carried out, e.g., by means of changing advancement of the sheets, thereby causing a distance to be altered. The separating device may therefore be a controllable transport means, e.g., a transport belt or transport rollers. The separating device may serve for sheet transport in longitudinal and/or transverse directions. It may be provided that the separating device is automatically activatable and deactivatable. It may be provided that automatic activating and deactivating of the separating device is carried out via at least one setting which is part of the series-specific set of settings.

One further development may be characterized in that the folding machine has at least one blow-air pipe. It may be provided that the blow-air pipe has a single opening for expelling blow air. This opening may preferably be at a lower end of the pipe. It may be provided that the blow-air pipe has multiple openings for expelling blow air. It may be provided that the blow-air pipe is settable depending on the format width of the sheets to be processed, preferably automatically and alternatively by hand. It may be provided that the blow-air pipe is supplied with blow air via a line, and that an automatically activatable and deactivatable valve is present in the line. It may be provided that automatic activating and deactivating of the valve is carried out via at least one setting which is part of the series-specific set of settings. In this way, the blow air may be clocked, e.g., at the clock rate of the sheets to be processed.

One further development may be characterized in that automatic activating and deactivating of the valve and automatic activating and deactivating of the slitter shaft are carried out attuned to each other. It may be provided that automatic activating and deactivating of the valve and automatic activating and deactivating of the slitter shaft are carried out concurrently.

It is a preferred further development the production method that edge trimming is carried out and any edge strips arising therefrom are carried off supported by blow air. The blow-air delivery is automatically activated or deactivated or maintained upon changing encoding.

The control carries out the job selection based on the encoding, and the corresponding program is loaded. Some manual adaptations may potentially still be needed but they are displayed to the operator. By means of the loaded program, (typically) one of the, e.g., three slitter shafts in the slitter shaft station is engaged while the slitter shafts not needed remain open. The three slitter shafts are variously equipped and enable three different machining procedures. They may vary in terms of format width (e.g., edge trimming for A4 and A3 in shafts located in succession) and in terms of machining (cutting, perforating, or grooving). The prestored jobs which are read from the encoding match the preset slitter shafts. Upon detection of the barcode, the corresponding slitter shafts are lifted or lowered. The slitter shafts may also be set independently of the program to set extended programs which are not part of the default settings. In the second station, a buckle folding unit, there are, e.g., three slitter shafts as well which can preferably be set by the control in the same way as those in the slitter shaft station. They are an upstream slitter shaft and two downstream slitter shafts. The actual folding unit has, e.g., six buckle plates. Different folding patterns can be realized (examples: four pages folded portrait and landscape, 6 pages folded by concertina or over-and-over folds, and six pages folded by concertina, over-and-over, gate folds or parallel-folded 2 times). Separating is carried out in the output tray and enables the various jobs to be separated more easily in the output tray. If operation is interrupted by push-to-stop (and potentially a new program is loaded), the output tray waits for the final sheet and thereupon adjusts the separating device. Upon the machine automatically starting up again, the next sheets continue to be collected in the output tray at a lateral offset from the previous sheets.

The parts of the apparatus for blow-air edge trimming removal are, e.g., a servicing unit, an electromagnetically driven pneumatic valve, blow pipes with clampable brackets, and baffles for paper strip guiding after being blown out. The optional servicing unit with a filter limits the pressure coming from the supply of compressed air. The valve opens and closes to activate or deactivate the blow air depending on the program. The two blow pipes are positioned directly behind the slitters of the upstream slitter shaft of the station. The blow pipes each create a localized airflow which blows against the separated edge trimming from above and pushes the paper strips downward. The paper strips deflected downward strike the baffles and are directed out of the machine. The blow air additionally supports in transporting them away by accelerating the paper strip, flowing along the baffles, from behind. The blow air is only active when the machine is running and the upstream slitter shaft is lowered. The control monitors these two conditions and correspondingly switches the blow air on or off.

Other features which are considered as characteristic for the invention are set forth in the appended claims.

Although the invention is illustrated and described herein as embodied in a method for operating an assembly of a digital printing machine and a folding machine, assembly of such machines, and production method for changing jobs, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIGS. 1 to 3 show preferred exemplary embodiments of the invention and of the further developments. In the figures, corresponding features are provided with the same reference symbols throughout. Reference symbols repeating in the figures have been partially omitted for reasons of clarity.

FIG. 1 shows a schematic representation of a preferred exemplary embodiment of a machine assembly according to the invention in operation or during production.

FIG. 2 shows a perspective view of a preferred exemplary embodiment of a pair of blow-air pipes of a folding machine in the machine assembly according to the invention.

FIG. 3 shows a sectional view taken through a preferred exemplary embodiment of a slitter shaft station of a folding machine in the machine assembly according to the invention.

### DETAILED DESCRIPTION OF THE INVENTION

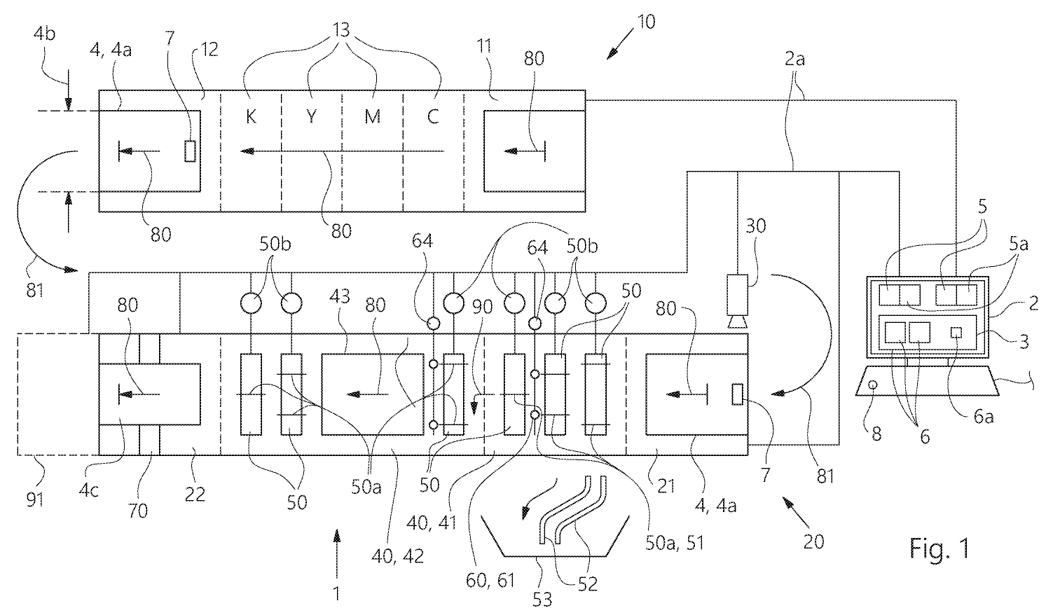

The assembly of production machines 1 for industrial manufacture of graphics articles shown in FIG. 1 comprises at least one digital computer 2 with a digital memory 3, at least one digital printing machine 10, and at least one finishing machine 20, in particular a folding machine. The computer 2 is connected to the machines 10 and 20 via connections 2a (wired or wireless) at least for controlling and/or transmitting data and/or settings. The computer 2 is preferably a workflow computer. Preferably, the production machines 1 also exhibit their own machine computers for operation of the respective machine.

The digital printing machine 10, in particular an ink-jet printing machine, creates printed products 4 which are output as sheets 4a having a format 4b and then delivered to finishing. The finishing machine 20 processes the sheets 4a delivered thereto (cf. the transitioning 81) and creates finished printed products 4c which are output as well. The digital computer 2 makes the jobs needed or their job data 5 and the associated settings 5a needed available to the machines 10 and 20.

According to the invention, series 6 of like or similar jobs or job data 5 are grouped, and for each series 6, a series-specific set 6a of settings 5a is provided. To detect when a series 6 changes or when a set 6a needs to be changed automatically, encoding 7 that may be sensed is printed onto each sheet 4a. The encoding may identify the product (that is, e.g., may comprise an ID) and may be utilized to retrieve the associated settings (e.g., via the ID). As a consequence, production is highly automated and may be operated in a push-to-stop mode. An actuator 8 for the push-to-stop mode present at the computer 2 therefore normally does not need to be actuated. It may be provided, e.g., that two or more like jobs a require the identical settings A, and two or more like jobs b require the identical settings B. These jobs are then preferably grouped automatically to form series [aa…a] having set A and series [bb…b] having set B. A job c similar to job b having setting C may be integrated to form series [bb…bc] having set B, wherein c is processed with setting B, or to form series [bb…bc] having set BC, wherein there is a change from B to C before job c.

The digital printing machine 10 comprises a feeder 11 for the printing substrate to be printed, preferably as a sheet or alternatively as a continuous web, as well as an output 12 for the sheets 4a (which may be transverse cut from the continuous web, as appropriate). Printing is carried out in a number of printing units 13, in particular in ink-jet printing units, for example for the colors CMYK or CMYKOGV. The finishing machine 20 also comprises a feeder 21 for the sheets 4a and an output 22, or delivery 22, for the printed products 4c.

Arranged in the feeder 21 is a camera 30 or a sensor 30 which senses the respective encoding 7 of the sheets 4a and transmits it to the computer 2. In this way, it is detected when a job 5 changes, i.e., when sheets 4a are processed with changing encoding 7. In this case, the computer 2 may transmit a changing set 6a or settings to the finishing machine 20 provided this is required. Alternatively, the settings may also be maintained if the two jobs are processed with like settings. That is, if the encoding changes, it may be checked whether alterations to settings are required.

The finishing machine 20 comprises multiple stations 40, in particular a slitter shaft station 41 and a buckle folding station 42, wherein the latter has a folding apparatus 43 with folding rollers and buckle plates. The slitter shaft station 41 has multiple slitter shafts 50 with (circular) slitters 50a arranged thereon. The slitter shafts 50 may be adjusted and halted via respective adjusters 50b, implementing the adjustment motion 50c. An adjusted slitter shaft 50 may, for example, implement edge trimming 51, cutting off an edge strip 52 from the sheet 4a and delivering it to waste disposal 53.

The edge strips 52 may be removed supported by blow air. To this end, blow-air pipes 60 with respective openings 61 for expelling blow air 62 may be arranged in the proximity of the slitters 50a. Both the slitters 50a and the blow-air pipes 60 may preferably be set depending on the format 4b. For changing edge trimmings 51, the computer 2 may adjust the respectively appropriate slitter shaft 50 via the controllable adjusters 50b. Likewise, the computer 2 may activate or deactivate removal of the edge strips 52 supported by blow air via controllable valves 64 in the lines 63 to the blow-air pipes 60. It is therefore an advantage that the pipes 60 do not need to be removed but are only deactivated.

Upon a change in jobs 5, the computer 2 may drive a separating device 70 such that it separates the printed products 4c of the individual jobs from one another.

Following the output 22, a robot 91 with a movable robot arm may be arranged which grasps the printed products 4c or stacks of such products and, for example, stacks them on a pallet.

The finishing machine 20 is shown in a straight implementation. However, preferably at the location 90, there may additionally be a turning station for 90° redirection about a horizontal axis. The sheets may be transported to a frontal stop and then transported onwards in parallel thereto. In this way, the edge trimming may be carried out both in a longitudinal direction (before turning) and perpendicular thereto (after turning).

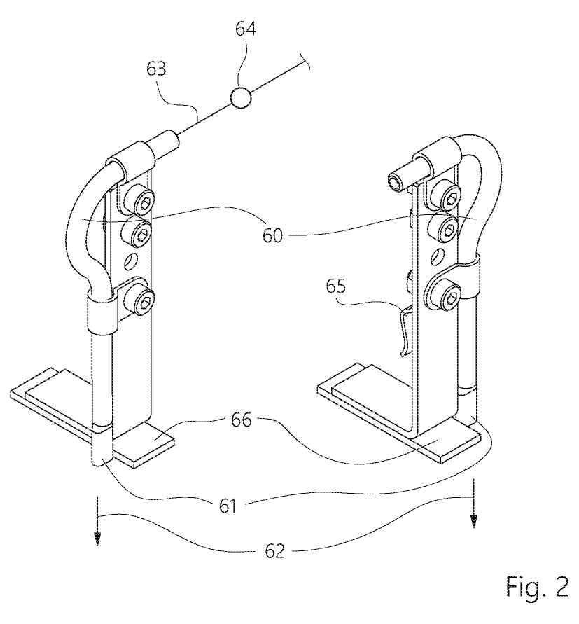

FIG. 2 shows a pair of blow-air pipes 60 for edge trimming of the sheets 4a on both sides. At their lower ends, the pipes 60 have respective openings 61 from which the blow air 62 exits directed at the edge strip 52 to be removed. Supply with blow air is carried out via respective lines 63 each comprising one controllable valve 64 (only shown on one of the two pipes). The pipes 60 may be arranged and fixed in the machine at the corresponding locations for edge trimming by means of clamping mounts 65. Also, at the lower end of a support, one baffle 66 each is arranged for the edge strip 52.

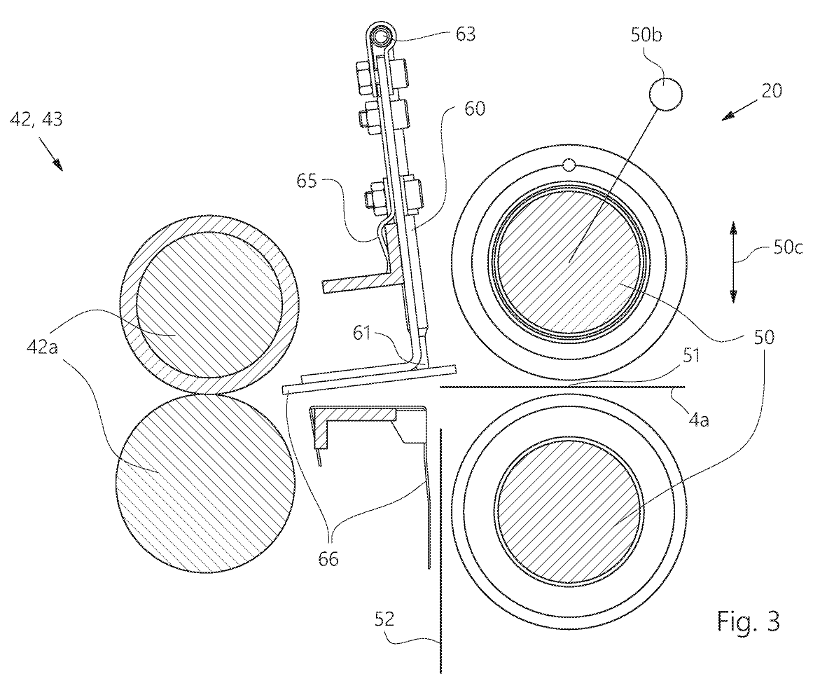

FIG. 3 shows an installation site of such a blow-air pipe 60. The edge trimming 51 is carried out by means of two slitter shafts 50, at least the top one of which can be activated or deactivated by means of an adjuster 50b(cf. the adjustment motion 50c). To remove the edge strip 52 from the sheet 4a, the blow-air pipe 60 and at least two baffles 66 are present. The edge-trimmed sheet 4a be supplied to the first rollers 42 a of a folding apparatus 43.

The following is a summary list of reference numerals and the corresponding structure used in the above description of the invention:
1 assembly of production machines
2 digital computer
2a connection(s)
3 digital memory
4 printed products
4a sheets
4b format of the sheets, in particular format width
4c finished printed product
5 jobs or job data
5a settings
6 series of like or similar jobs or job data
6a series-specific set of settings
7 encoding
8 actuator for push-to-stop mode
10 digital printing machine
11 feeder
12 output
13 printing units, in particular ink-jet printing units
20 finishing machine, in particular folding machine
21 feeder
22 output
30 camera or sensor
40 station(s)
41 slitter shaft station
42 buckle folding statio
42a folding rollers
43 folding apparatus with folding rollers and buckle plates
50 slitter shaft(s)
50a slitters
50b adjuster(s)
50c adjustment motion
51 edge trimming or location of edge trimming
52 edge strips
53 waste disposal
60 blow-air pipe(s)
61 opening(s)
62 blow air
63 line
64 valve
65 clamping mounts
66 baffle(s)
70 separating device
80 conveying direction
81 transitioning
90 90° redirection
91 robot

1. A method for operating an assembly formed of at least one digital printing machine and at least one folding machine, wherein the digital printing machine is configured to create changing jobs of printed products based on respective job data, and the folding machine is configured to finish the printed products by at least one of folding, cutting, or grooving sheets, and wherein the folding machine is set for each of the jobs, the method comprising:
grouping, in an automated manner, multiple jobs to be finished with like or similar settings in terms of finishing, to form respective series of consecutive jobs;
for each series of consecutive jobs, specifying a set of series-specific settings and digitally saving the series-specific settings for the folding machine; and
sequentially creating the series with the digital printing machine and finishing at the folding machine with the series-specific settings each provided in an automated manner.

2. The method according to claim 1, which comprises providing the sheets with printed encoding created in the digital printing machine, and using the encoding to provide the set of series-specific settings respectively needed for finishing, and, when the encoding changes, automatically changing the set of series-specific settings.

3. The method according to claim 1, which comprises operating the folding machine in a push-to-stop mode, by processing changing jobs by the folding machine automatically and sequentially without any controlling intervention by an operator.

4. The method according to claim 1, which comprises subjecting the sheets to edge trimming in the folding machine, and carrying off any edge strips arising during the edge trimming by blow air, and automatically activating, maintaining, or deactivating a delivery of the blow-air when the encoding changes.

5. The method according to claim 4, which comprises setting a blow-air pipe in dependence on a format of sheets to be processed, and automatically altering or maintaining a format setting when the encoding changes.

6. An assembly, comprising:
a digital printing machine and a folding machine; and
a digital computer; and
wherein the assembly is operable for performing the method according to claim 1; and
wherein said digital computer is configured to transmit the job data to said digital printing machine and to transmit the series-specific settings to said folding machine.

7. The assembly according to claim 6, wherein said folding machine has at least one station being at least one of a slitter shaft station or a buckle folding station, said at least one station comprises an automatically activatable and deactivatable slitter shaft, and an automatic activation and deactivation of said slitter shaft is effected via at least one setting that forms part of the series-specific set of settings.

8. The assembly according to claim 6, wherein said folding machine has a feeder for sheets to be processed, and said feeder includes a camera or a sensor configured to sense printed encoding on the sheets.

9. The assembly according to claim 6, wherein said folding machine comprises an output with a separating device configured to handle changing jobs and for separating the jobs from one another for further handling, and said separating device is automatically activatable and deactivatable, wherein an automatic activation and deactivation of said separating device is effected via at least one setting that forms part of the series-specific set of settings.

10. The assembly according to claim 6, wherein said folding machine comprises at least one blow-air pipe, a line for supplying blow air to said blow-air pipe, and an automatically activatable and deactivatable valve in said line, and wherein an automatic activation and deactivation of said valve is effected via at least one setting that forms part of the series-specific set of settings.

11. The assembly according to claim 10, wherein the automatic activation and deactivation of said valve and an automatic activation and deactivation of a slitter shaft of said folding machine are carried out attuned to one another.

12. A production method for automatic production of changing jobs of printed products, the method comprising:
printing and encoding print products in a digital printing machine and finishing the products in a finishing machine;
operating both the digital printing machine and the folding machine in a push-to-stop mode under computer control, wherein job series of like or similar jobs are created under computer control and provided with changing encoding and finished sequentially upon changing encoding with changing series-specific settings.

13. The production method according to claim 12, which comprises subjecting the product to edge trimming and carrying off any edge strips arising from the edge trimming by blow air, and thereby automatically activating or deactivating or maintaining a delivery of blow air upon changing encoding.
